(19) United States
(12) Patent Application Publication
(10) Pub. No.: US 2005/0218778 A1
(43) Pub. Date: Oct. 6, 2005

(54) Deflection yoke and picture tube apparatus using the same

(75) Inventor: Katsuyo Iwasaki, Nishinomiya-shi (JP)

Correspondence Address: HAMRE, SCHUMANN, MUELLER & LARSON, P.C., P.O. BOX 2902-0902, MINNEAPOLIS, MN, 55402, US

(73) Assignee: MATSUSHITA TOSHIBA PICTURE DISPLAY CO., LTD., Takatsuki-shi (JP)

(21) Appl. No.: 11/088,477

(22) Filed: Mar. 23, 2005

(30) Foreign Application Priority Data
Apr. 6, 2004 (JP) 2004-112416

(51) Int. Cl. H01J 29/70

(52) U.S. Cl. 313/440

(57) ABSTRACT

When a deflection yoke is provided by winding horizontal deflection coils so that right and left ends of its bend portion on a screen face side protrude farther toward the screen face side than the center of the bend portion does, works for attaching vertical deflection coils and a core to an insulating frame can be carried out stably. The insulating frame is resin-molded so that an opening on the screen face side is shaped along the bend portion on the screen face side of a pair of upper and lower horizontal deflection coils. Protrusions (convexes) are provided at four positions between right/left portion “A” in a X-axis (horizontal axis) direction and top/bottom portion “B” in a Y-axis (vertical axis) direction of a periphery of the opening on the screen face side of the insulating frame.

### FIELD OF THE INVENTION

The present invention relates to a deflection yoke that is used for a picture tube apparatus such as a television set and a projection tube apparatus in order to deflect an electron beam emitted from an electron gun in horizontal and vertical directions. The present invention relates also to a picture tube apparatus using the deflection yoke.

### BACKGROUND OF THE INVENTION

Generally, for higher resolution of projection-type projection televisions, a deflection field of a deflection yoke included in its projection tube apparatus is a substantially uniform field. Thus, pincushion distortions 1 (1a, 1b) of an image that occur due to geometric reasons as shown in FIG. 8 remain, and a correction circuit of a projection television set corrects these pincushion distortions 1. Particularly, it is known that the proportion of the power necessary to correct the pincushion distortion 1a in upper and lower portions of the screen accounts for at least 10% of the entire power consumption of a projection television set. With an increasing demand for energy saving in recent years, projection television set manufacturers are facing design difficulties.

Conventionally, in order to solve the above-described problems, techniques discussed below have been proposed (see e.g., JP 2003-123669A).

FIG. 9 shows a side view of a conventional deflection yoke. As shown in FIG. 9, the conventional deflection yoke 2 is made up of horizontal deflection coils 3, vertical deflection coils 4, and a core 5. In the vicinity 6 of an opening on the screen face side of the deflection yoke 2, horizontal correction coils 7 and vertical correction coils 8 are disposed at the left and right and the top and bottom of the opening, respectively. Here, the horizontal correction coils 7 are connected to the horizontal deflection coils 3 in series, and the vertical correction coils 8 are connected to the vertical deflection coils 4 in series.

The operation of the conventional deflection yoke 2 configured as above, particularly the operation of the vertical correction coils 8 is described below with reference to FIGS. 9 and 10. FIG. 10 is a diagram for schematically describing the operation of the conventional deflection yoke. As shown in FIGS. 9 and 10, when a vertical deflection current passes through the vertical deflection coils 4, a current passes through the vertical correction coils 8 disposed at the top and bottom in the vicinity 6 of the opening on the screen face side of the deflection yoke 2, thereby generating a correction field 9. Thus, an electron beam 10 is subjected to the Lorentz force 11 in the direction away from the Z-axis (the tube axis) in the vicinity of the upper and lower portions of the screen, and the pincushion distortion in the upper and lower portions of the screen is corrected. Similarly, when a horizontal deflection current passes through the horizontal deflection coils 3 and when a current passes through the horizontal correction coils 7, pincushion distortion in the left and right portions of the screen is corrected.

However, in the technique disclosed in JP 2003-123669A, the horizontal correction coils 7 and the vertical correction coils 8 are necessary in addition to the deflection yoke 2, and the number of manufacturing steps required for assembling these coils also increases, resulting in a problem of an increase in the cost of the deflection yoke 2.

### SUMMARY OF THE INVENTION

In order to solve the above-mentioned problem, the present applicant has proposed a technique of correcting the pincushion distortion in the upper and lower portions of the screen efficiently without using vertical correction coils or the like, by winding horizontal deflection coils so that right and left ends of its bend portion on the screen face side protrude farther toward the screen face side than the center of the bend portion does.

An object of the present invention is to provide a deflection yoke that has thus wound horizontal deflection coils and that allows stable processes for attaching the vertical deflection coils and the cores to the insulating frame, and also a picture tube apparatus using the deflection yoke.

In order to achieve the above-mentioned object, a configuration of a deflection yoke according to the present invention includes: an insulating frame; a pair of upper and lower horizontal deflection coils that are disposed inside of the insulating frame and generate a horizontal deflection field for deflecting an electron beam in a horizontal direction; a pair of right and left vertical deflection coils that are disposed outside of the insulating frame and generate a vertical deflection field for deflecting the electron beam in a vertical direction; and a core disposed outside of the vertical deflection coils. The horizontal deflection coils are wound so that right and left ends of its bend portion on the screen face side protrude farther toward the screen face side than the center of the bend portion does. The insulating frame is formed so that an opening on the screen face side is shaped along the bend portion on the screen face side of the pair of upper and lower horizontal deflection coils. Convexes protruding toward the screen face side are provided at positions between right/left portion and top/bottom portion of a periphery of the opening on the screen face side of the insulating frame.

It is also preferable in the configuration of the deflection yoke according to the present invention that the convexes have a height being set so that tip ends of the convexes are in contact with a plane containing the right and left portions of the periphery of the opening on the screen face side of the insulating frame and being perpendicular to a Z-axis (tube axis).

It is also preferable in the configuration of the deflection yoke according to the present invention that the convexes are provided on the insulating frame removably.

A configuration of a picture tube apparatus according to the present invention includes: a valve made up of a face panel having a screen face on its external surface, a funnel connected to a rear portion of the face panel; an electron gun that is housed in a neck portion of the funnel; and a deflection yoke that is mounted at an outer circumference of the funnel on the neck portion side, and deflects an electron beam emitted from the electron gun in horizontal and vertical directions. The deflection yoke is the deflection yoke of the present invention.

According to the present invention, even when an insulating frame is placed on a workbench, with its opening on the screen face side facing downward, the insulating frame will not become unstable. Therefore, processes for attaching the vertical deflection coils and the core to the insulating frame can be carried out stably. Moreover, even when the deflection yoke is disposed with its opening on the screen face side facing downward during transport of the deflection yoke, the deflection yoke will not topple and be damaged due to external vibration or the like. Therefore, the reliability of the deflection yoke can be improved.

### BRIEF DESCRIPTION OF THE DRAWINGS

FIG. 1 is a side view showing an insulating frame for a deflection yoke according to an embodiment of the present invention.

FIG. 2 is an exploded perspective view showing a deflection yoke according to an embodiment of the present invention.

FIG. 3 is a side view showing an assembled deflection yoke according to an embodiment of the present invention.

FIG. 4 is a top view showing a projection tube apparatus equipped with a deflection yoke according to an embodiment of the present invention.

FIG. 5 is a side view showing a deflection yoke according to an embodiment of the present invention (from which an insulating frame is omitted).

FIG. 6A is a top view of a projection tube apparatus on which horizontal deflection coils constituting a deflection yoke are mounted according to an embodiment of the present invention, and FIG. 6B is a side view thereof (top half only).

FIG. 7 is a side view showing another example of an insulating frame for a deflection yoke according to an embodiment of the present invention.

FIG. 8 is a diagram for schematically illustrating the pincushion distortions in a conventional projection tube apparatus.

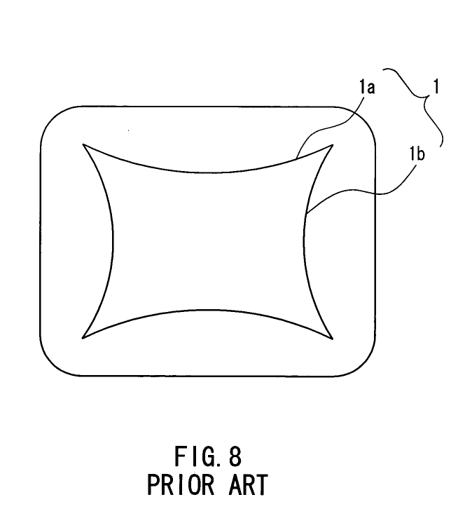

FIG. 9 is a side view showing a conventional deflection yoke.

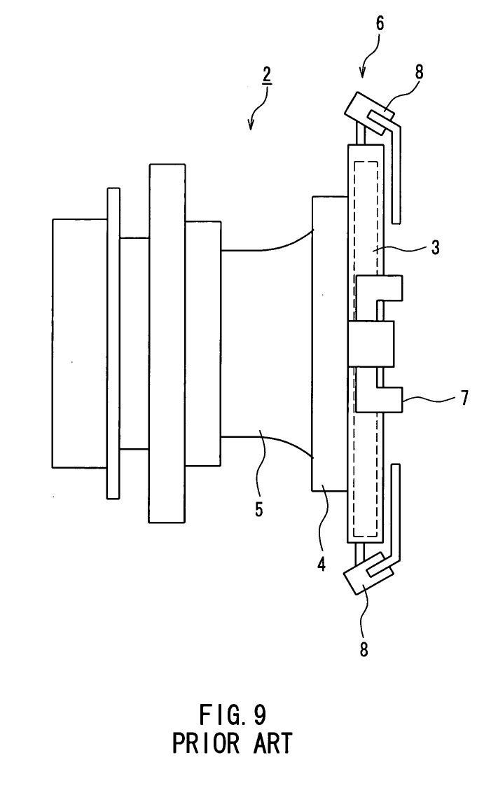

FIG. 10 is a diagram for schematically illustrating the operations of the conventional deflection yoke.

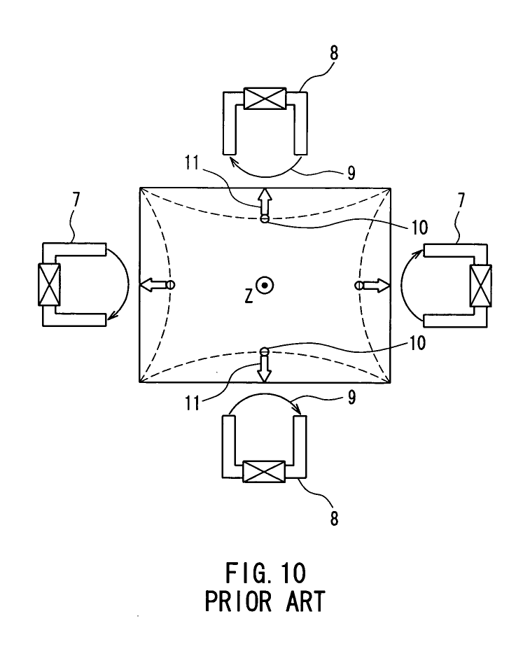

### DETAILED DESCRIPTION OF THE INVENTION

Hereinafter, the present invention will be described more specifically by way of an embodiment.

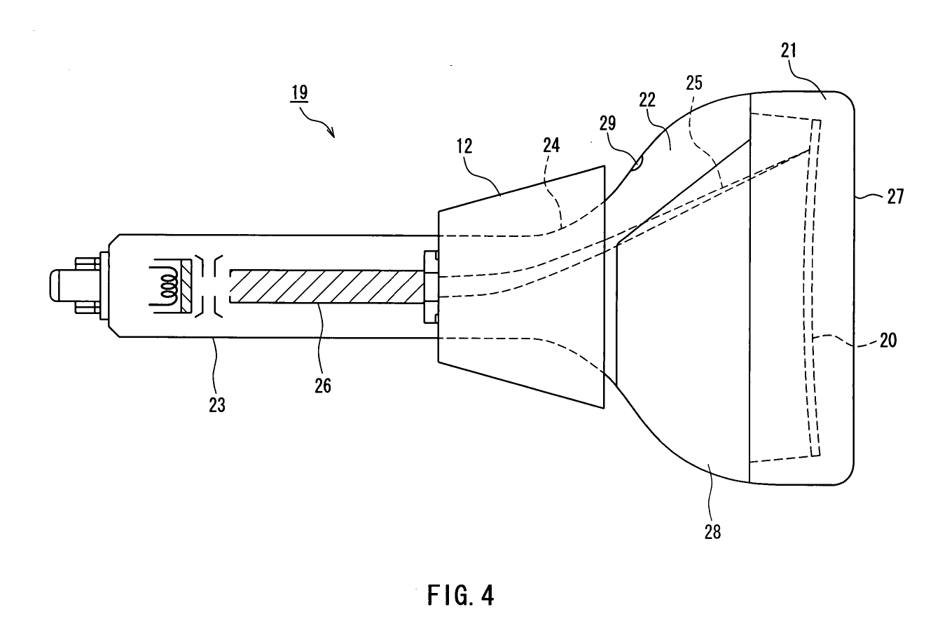

First, a projection tube apparatus equipped with a deflection yoke according to this embodiment is described with reference to FIG. 4. FIG. 4 is a top view showing a projection tube apparatus equipped with a deflection yoke according to an embodiment of the present invention.

As shown in FIG. 4, a projection tube apparatus 19 includes: a valve (vacuum envelope) made up of a face panel 21 made of glass or the like and having a substantially rectangular display portion 20 on its inner surface, a funnel 22 and a cylindrical neck portion 23 also made of glass or the like and connected to the rear portion of the face panel 21; and an electron gun 26 that emits an electron beam 25 and is housed in the neck portion 23. Here, a substantially rectangular screen face 27 is formed on an external surface of the face panel 21 that is opposite to the display portion 20. Furthermore, a deflection yoke 12 for deflecting the electron beam 25 emitted from the electron gun 26 in the vertical and horizontal directions is mounted on an outer circumference of the funnel 22 on the neck portion 23 side.

The funnel 22 has a portion with a small diameter, or what is known as a yoke portion 24, extending from its junction with the neck portion 23 to an end portion of the deflection yoke 12 on the screen face 27 side. An external conductive material 28 is coated on the external surface of the funnel 22 from the vicinity of an opening on the screen face 27 side of the deflection yoke 12 to a connection portion between the face panel 21 and the funnel 22. Furthermore, an anode portion 29 is provided between the yoke portion 24 and the connection portion between the face panel 21 and the funnel 22, and a predetermined distance is kept between the end portion of the deflection yoke 12 on the screen face 27 side and the anode portion 29 for insulation. Furthermore, an internal conductive material (not shown) also is coated on the internal surface of the funnel 22 from the vicinity of the opening on the screen face 27 side of the deflection yoke 12 to the connection portion between the face panel 21 and funnel 22. By obtaining a desired capacitance between the external conductive material 28 and the internal conductive material, minute variation of a high voltage applied to the anode portion 29 is absorbed to prevent adverse effects on the image quality.

In the projection tube apparatus 19 having a configuration as described above, an image is formed on the screen face 27 by accelerating the electron beam 25 emitted from the electron gun 26 with a high voltage of about 30 kV applied to the anode portion 29, deflecting the electron beam 25 in the horizontal and vertical directions with the horizontal deflection field and vertical deflection field generated by the deflection yoke 12 in the yoke portion 24, and scanning the display portion 20 horizontally and vertically.

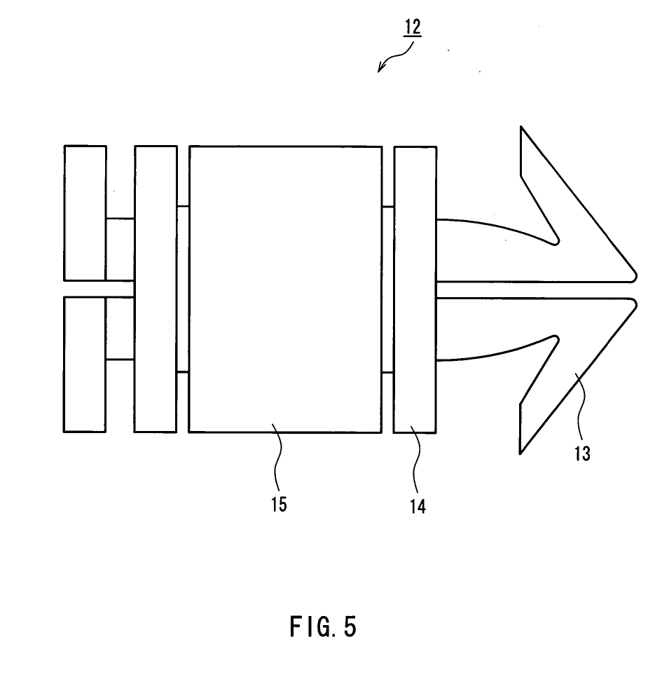

FIG. 5 shows a side view of a deflection yoke of this embodiment (from which an insulating frame is omitted). As shown in FIG. 5, the deflection yoke 12 of this embodiment includes: a pair of upper and lower horizontal deflection coils 13 that generate a horizontal deflection field for deflecting the electron beam 25 in the horizontal direction; a pair of right and left vertical deflection coils 14 that generate a vertical deflection field for deflecting the electron beam 25 in the vertical direction and are disposed outside of the horizontal deflection coils 13; and a ferrite core 15 disposed outside of the vertical deflection coils 14.

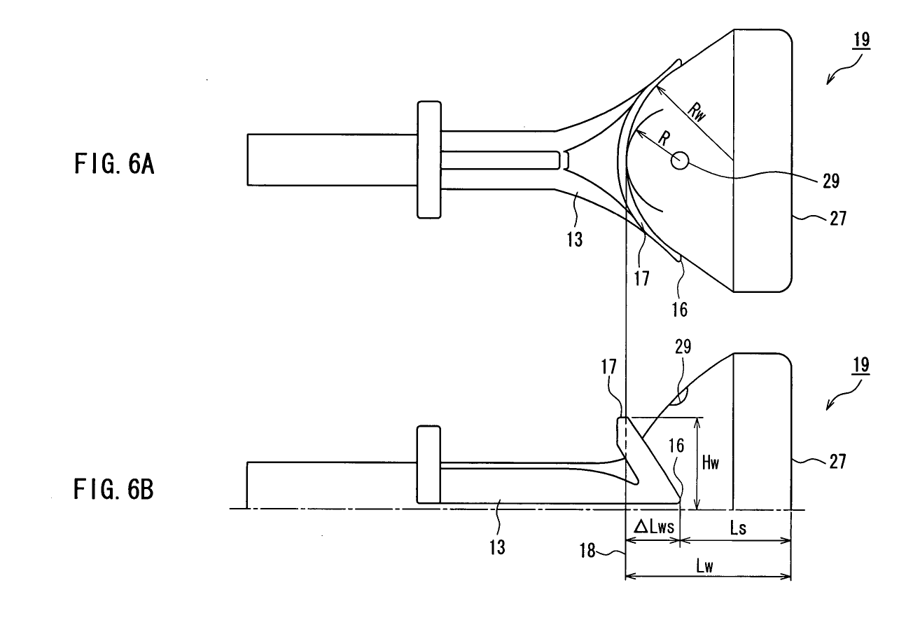

FIG. 6A shows a top view of a projection tube apparatus on which horizontal deflection coils constituting the deflection yoke are mounted according to this embodiment, and FIG. 6B shows a side view of the top half thereof.

As shown in FIGS. 6A and 6B, in the projection tube apparatus 19 equipped with a deflection yoke of this embodiment, a distance Ls between an end portion 16 of the horizontal deflection coils 13 on the screen face 27 side and the screen face 27 is set to 65 mm. Furthermore, in the projection tube apparatus 19 equipped with the deflection yoke of this embodiment, the distance Ls between the end portion 16 of the horizontal deflection coils 13 on the screen face 27 side and the screen face 27 is set smaller than a distance Lw between a position 18 on the Z-axis (tube axis) where a height Hw in the direction of Y-axis (vertical axis) of a bend portion 17 on the screen face 27 side of the horizontal deflection coils 13 is highest and the screen face 27, and a difference ΔLws=Lw−Ls between Ls and Lw is set to 17 mm. Furthermore, when viewed from above (FIG. 6A), a radius of curvature Rw of the bend portion 17 on the screen face 27 side of the horizontal deflection coils 13 is set larger than a segment R connecting the position 18 on the Z-axis (tube axis) where the height Hw in the direction of Y-axis (vertical axis) of the bend portion 17 is highest and the anode portion 29. It should be noted that the foregoing dimensional settings are for the 16 cm (7 inches) projection tube apparatus.

By providing dimensional settings as described above, the pincushion distortions in upper and lower portions of the screen can be corrected efficiently, and the effects of the minute variation of a high voltage applied to the anode portion 29 on the image quality also can be suppressed. Furthermore, a desired insulation distance can be ensured between the horizontal deflection coils 13 and the anode portion 29.

As mentioned above, the horizontal deflection coils 13 of the deflection yoke 12 according to this embodiment are wound so that the right and left ends of the bend portion 17 on the screen face 27 side protrude farther toward the screen face 27 side by 17 mm than the center of the bend portion 17 does.

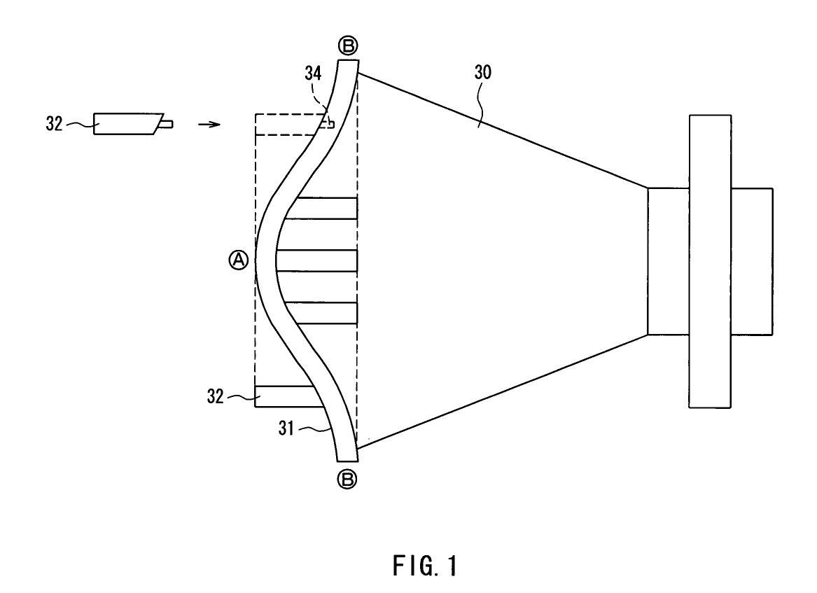

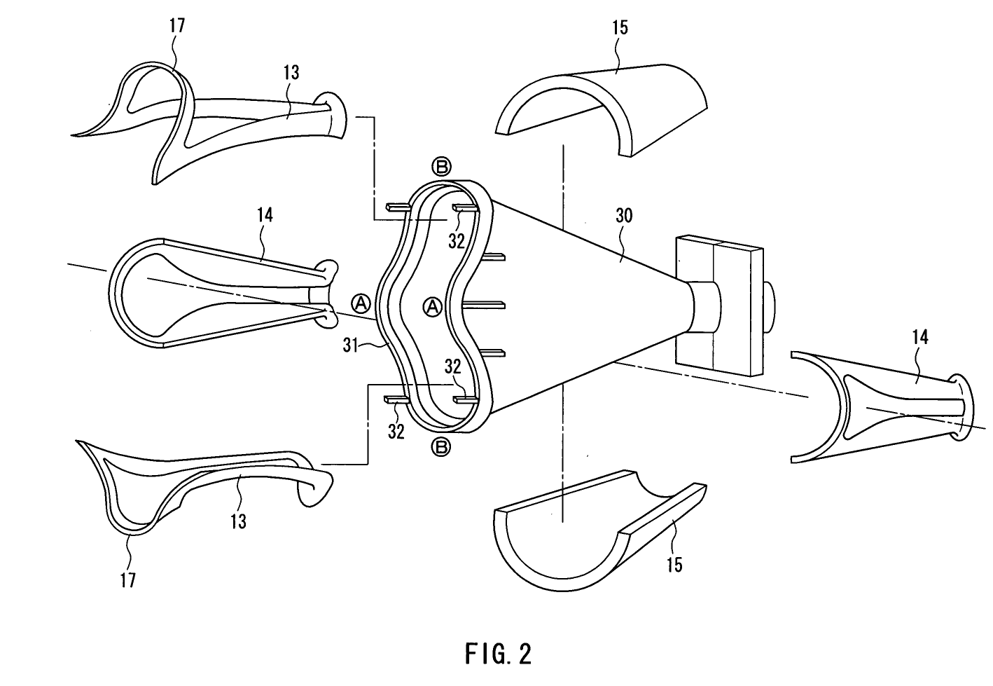

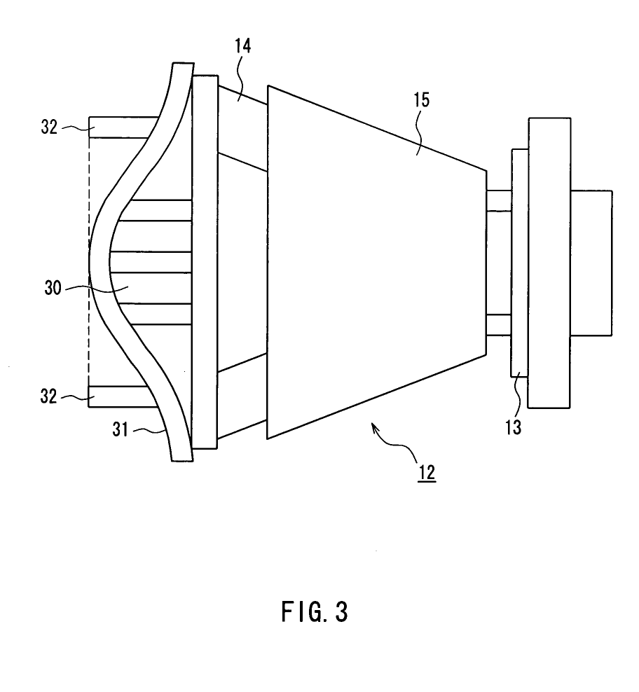

Next, the configuration of the deflection yoke including an insulating frame suitable for supporting the horizontal deflection coils 13 in such a wound state will be described below by referring to FIGS. 1-3. FIG. 1 is a side view showing an insulating frame for a deflection yoke in an embodiment of the present invention. FIG. 2 is an exploded perspective view showing a deflection yoke in an embodiment of the present invention, and FIG. 3 is a side view showing an assembled deflection yoke in an embodiment of the present invention.

As shown in FIGS. 1 and 2, the insulating frame 30 of the deflection yoke 12 according to this embodiment is resin-molded so that its opening 31 on the screen face 27 side will be shaped along the bend portion 17 on the screen face 27 side (the left side in FIGS. 1 and 2) of the pair of upper and lower horizontal deflection coils 13. That is, the opening 31 on the screen face 27 side of the insulating frame 30 has right and left portions “A” in the X-axis (horizontal axis) direction protruding toward the screen face 27 side more than the top and bottom portions “B” in the Y-axis (vertical axis) direction do.

It is noted that the processes for attaching the vertical deflection coils and the ferrite core to the insulating frame are carried out in general by placing the insulating frame on a workbench, with its opening on the screen face side facing downward. However in this embodiment, as mentioned above, the opening 31 on the screen face 27 side of the insulating frame 30 has the right and left portions “A” in the X-axis (horizontal axis) directions protruding toward the screen face 27 side more than the top and bottom portions “B” in the Y axis (vertical axis) directions do. In this state, the insulating frame 30 will be unstable when it is placed on a workbench, and thus attaching the vertical deflection coils 14 and the ferrite core 15 to the insulating frame 30 cannot be carried out stably.

In light of this, in this embodiment as shown in FIGS. 1 and 2, pin-like protrusions (convexes) 32 protruding toward the screen face 27 side are provided at four positions between the right/left portion “A” in the X-axis (horizontal axis) direction and the top/bottom portion “B” in the Y-axis (vertical axis) direction of the periphery of the opening 31 on the screen face 27 side of the insulating frame 30. Here, the respective protrusions 32 have a length (height) being set so that the tip ends will be in contact with a plane including the right and left portions “A” in the X-axis (horizontal axis) direction of the opening 31 on the screen face 27 side of the insulating frame 30 and being perpendicular to the Z-axis (tube axis). Therefore, even when the insulating frame 30 is placed on a workbench with its opening 31 on the screen face 27 side facing downward, the insulating frame 30 will not become unstable. As a result, processes for attaching the vertical deflection coils 14 and the ferrite core 15 to the insulating frame 30 can be carried out stably. Moreover, the respective protrusions 32 are inserted in holes 34 formed on the insulating frame 30 for attachment to the insulating frame 30. That is, the respective protrusions 32 are provided on the insulating frame 30 removably. Thereby, the respective protrusions 32 are attached to the insulating frame 30 only during a process of attaching the vertical deflection coils 14 and the ferrite core 15 to the insulating frame 30, or during transportation of the deflection yoke 12. When equipping the deflection yoke 12 in the projection tube apparatus 19, the respective protrusions 32 can be detached from the insulating frame 30.

Next, a process of assembling the deflection yoke 12 in this embodiment will be described below by referring to FIG. 2.

First, the pair of upper and lower horizontal deflection coils 13 are disposed along the inner wall face of the insulating frame 30. Though not shown in FIG. 2, the front-end face, the inner wall face and the rear end face of the insulating frame 30 are processed previously for supporting the horizontal deflection coils 13.

Next, protrusions 32 protruding toward the screen face 27 side are attached at four positions between the right/left portion “A” in the X-axis (horizontal axis) direction and the top/bottom portion “B” in the Y-axis (vertical axis) direction of the periphery of the opening 31 on the screen face 27 side of the insulating frame 30.

Then, the insulating frame 30 with the pair of upper and lower horizontal deflection coils 13 is placed on a workbench, with its opening 31 on the screen face 27 side facing downward. In this case, in the opening 31 on the screen face 27 side of the insulating frame 30, the right and left portions “A” in the X-axis (horizontal axis) direction protrude toward the screen face 27 side more than the top and bottom portions “B” in the Y-axis (vertical axis) direction do. However, as mentioned above, since the protrusions 32 protruding toward the screen face 27 side are attached at four positions between the right/left portion “A” in the X-axis (horizontal axis) direction and the top/bottom portion “B” in the Y-axis (vertical direction) direction of the periphery of the opening 31 on the screen face 27 side of the insulating frame 30, the insulating frame 30 can be placed stably on the workbench. In this state, a pair of right and left vertical deflection coils 14 are attached to the outside of the insulating frame 30, a ferrite core 15 is disposed on the outside of the pair of right and left vertical deflection coils 14, and the vertical deflection coils 14 and the ferrite core 15 are fixed to the insulating frame 30 with a resin such as a hot-melt or an adhesive. In this case, since the vertical deflection coils 14 and the ferrite core 15 are attached to the insulating frame 30 being in a stable state, the processes for attaching the vertical deflection coils 14 and the ferrite core 15 can be carried out stably.

In this manner, the pair of upper and lower horizontal deflection coils 13 and the pair of right and left vertical deflection coils 14 are supported on the insulating frame 30 while keeping electric insulation therebetween, and further a ferrite core 15 is attached, so that the deflection yoke 12 as shown in FIG. 3 is completed. The protrusions 32 can be detached at a stage where the deflection yoke 12 is completed. However, the protrusions 32 will be preferably remain in this stage for transportation of the deflection yoke 12. That is, by keeping the protrusions 32, the deflection yoke 12 is prevented from toppling to be damaged due to external vibration or the like even when placing the deflection yoke 12 with the opening 31 on the screen face 27 side of the insulating frame 30 facing downward. As a result, the reliability of the deflection yoke 12 can be improved.

Though this embodiment refers to an example where convexes are formed to protrude straight toward the screen face 27 side from the periphery of the opening 31 on the screen face 27 side of the insulating frame 30, the convexes can be curved alternatively.

Though the protrusions 32 in this embodiment are provided removably on the insulating frame 30, they can be fixed to the insulating frame 30 alternatively.

In this embodiment, the protrusions 32 are provided at four positions between the right/left portion “A” in the X-axis (horizontal axis) direction and the top/bottom portion “B” in the Y-axis (vertical axis) direction of the periphery of the opening 31 on the screen face 27 side of the insulating frame 30. There will be no substantial problem if this four-point-support structure is replaced by a three-point-support structure where the protrusions 32 are provided at only three positions.

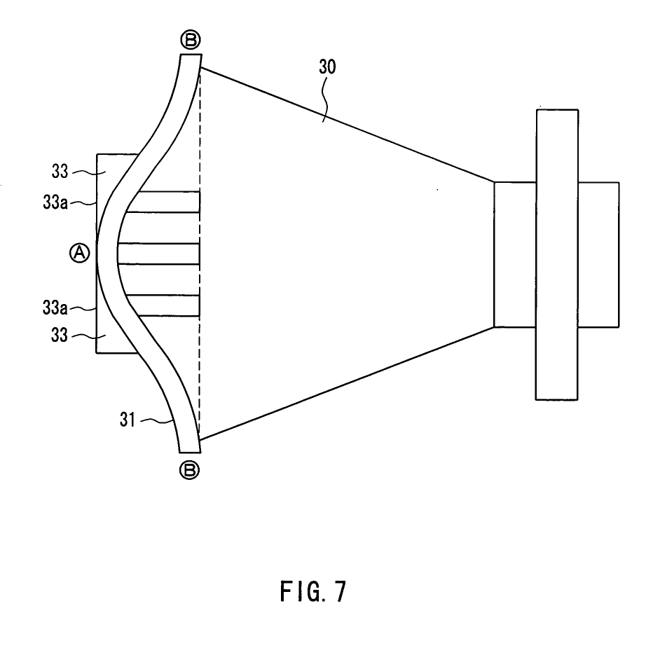

In this embodiment, pin-like protrusions 32 are described as an example of the convexes. However, the convexes are not limited to such a pin shape, but as shown in FIG. 7 for example, they can be plates 33 formed along the periphery of the opening 31 on the screen face 27 side of the insulating frame 30. In this case, the plates 33 will have a length (height) being set so that faces 33a on the screen face 27 side of the plates 33 will be in contact with a plane including the right and left portions “A” in the X-axis (horizontal axis) direction of the opening 31 on the screen face 27 side of the insulating frame 30 and being perpendicular to the Z-axis (tube axis). Also in this case, the plates 33 as the convexes can be provided removably to the insulating frame 30, or they can be fixed to the insulating frame 30. Also in this case, a three-point-support structure can be applied as well as the four-point support structure.

The description in this embodiment refers to an example of a deflection yoke 12 for a projection tube apparatus. However, the deflection yoke of the present invention will not be limited to the deflection yoke for a projection tube apparatus, but it can be applied as well to deflection yokes to be provided in other picture tube apparatuses such as a television set.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, all changes that come within the meaning and range of equivalency of the claims are intended to be embraced therein.

1. A deflection yoke comprising: an insulating frame; a pair of upper and lower horizontal deflection coils that are disposed inside of the insulating frame and generate a horizontal deflection field for deflecting an electron beam in a horizontal direction; a pair of right and left vertical deflection coils that are disposed outside of the insulating frame and generate a vertical deflection field for deflecting the electron beam in a vertical direction; and a core disposed outside of the vertical deflection coils, wherein
the horizontal deflection coils are wound so that right and left ends of its bend portion on the screen face side protrude farther toward the screen face side than the center of the bend portion does;
the insulating frame is formed so that an opening on the screen face side is shaped along the bend portion on the screen face side of the pair of upper and lower horizontal deflection coils; and
convexes protruding toward the screen face side are provided at positions between right/left portion and top/bottom portion of a periphery of the opening on the screen face side of the insulating frame.

2. The deflection yoke according to claim 1, wherein the convexes have a height being set so that tip ends of the convexes are in contact with a plane containing the right and left portions of the periphery of the opening on the screen face side of the insulating frame and being perpendicular to a Z-axis (tube axis).

3. The deflection yoke according to claim 1, wherein the convexes are provided to the insulating frame removably.

4. A picture tube apparatus comprising:
a valve made up of a face panel having a screen face on its external surface, a funnel connected to a rear portion of the face panel;
an electron gun that is housed in a neck portion of the funnel; and
a deflection yoke that is mounted at an outer circumference of the funnel on the neck portion side, and deflects an electron beam emitted from the electron gun in horizontal and vertical directions, wherein
the deflection yoke is any of the deflection yokes according to claim 1.
